(19) United States
(12) Patent Application Publication
(10) Pub. No.: US 2015/0046489 A1
(43) Pub. Date: Feb. 12, 2015

(54) SEARCH SYSTEM AND METHOD FOR EXPANDED ADMINISTRATIVE AREA USING NEARBY ADMINISTRATIVE AREA INFORMATION

(71) Applicant: Thinkware Systems Corporation, Seongnam-si (KR)

(72) Inventor: Yeon Jung KIM, Seongnam-si (KR)

(21) Appl. No.: 14/450,850

(22) Filed: Aug. 4, 2014

(30) Foreign Application Priority Data
Aug. 6, 2013 (KR) 10-2013-0093330

(51) Int. Cl. G06F 17/30

(52) U.S. Cl. CPC G06F 17/30241; G06F 17/30424
USPC 707/769

(57) ABSTRACT

Provided is a search system and method for an expanded administrative area using nearby administrative area information. A search system may include a setter configured to set, as a search area, an administrative district corresponding to an administrative name in response to a query comprising the administrative name, and a searcher configured to conduct a search associated with the query in the search area. Here, the setter may expand the search area to another administrative district adjacent to the administrative district when a search result obtained from the search area is unsatisfactory.

### CROSS-REFERENCE TO RELATED APPLICATION

This application claims the priority benefit of Korean Patent Application No. 10-2013-0093330, filed on Aug. 6, 2013, in the Korean Intellectual Property Office, the disclosure of which is incorporated herein by reference.

### BACKGROUND

1. Field of the Invention

Embodiments of the present invention relate to a search system and method for performing a nearby search function using an administrative area.

2. Description of the Related Art

Recently, with the development in information technology (IT), a geographic information system (GIS) in which a variety of geographical information is databased has been widely used. Location information, such as a longitude, a latitude, and an address, may be readily retrieved through the GIS.

In general, the GIS may collect geographic data from a public institution or a geographic information server and then may convert the geographic data to an appropriate map image and provide the map image to a user.

Meanwhile, a navigation system refers to a system that provides information for driving of a transportation device, such as a vehicle, using an artificial satellite. The navigation system may include a global positioning system (GPS) receiver to receive data from a GPS satellite orbiting the earth and to calculate a location of the navigation system based on the received data.

The navigation system may provide a variety of services, for example, a location service for notifying a user about a current location of a vehicle, a routing service of calculating an optimal route to a desired destination, and a guidance service for guiding a vehicle to be driven along the calculated route.

The GIS and the navigation system may include a database configured to store geographic data, and may provide geographic information and map information desired by a user through inquiry and analysis about spatial database of a relational database. For example, the Korean Registration Patent No. 10-0917768 discloses technology for conducting a search on a spatial query in a grid-based index environment.

Meanwhile, the GIS and the navigation system may provide a nearby search function using an administrative name by designating geographic data for each administrative unit, for example, “metropolitan city”, “megalopolis”, “-do”,“-si”, “-gun”, “-gu”, “-eup”, “-eup”, “-myeon”, “-dong”, and “-lee”, used to divide a map area.

For example, a query “temple around Bangi-dong” may be processed using the following two methods; a first query processing method of searching for “temples” located within a predetermined distance, for example, 2km, from central coordinates of “Bangi-dong” (see FIG. 1), and a second query processing method of searching for “temples” located in “Bangi-dong” (see FIG. 2).

Referring to FIG. 1, the first query processing method conducts a search by using, as central coordinates 101, coordinates indicating a public office of a corresponding administrative district or a point of interest (POI) of the administrative district and within a predetermined radius 100, for example, 2 km based on the central coordinates 101. Accordingly, a temple that is actually present within “Bangi-dong”, however, is not located within a corresponding radius may not be included in a search result based on a size of the radius. A temple that does not belong to “Bangi-dong”, however, is located within the corresponding radius may be included in the search result.

The second query processing method is conceived to enhance the first query processing method. Referring to FIG. 2, the second query processing method assigns an index to each administrative area 200 and thereby enables a search to be conducted for geographic data for each index, using the assigned index. That is, the second query processing method may retrieve “temples” located in “Bangi-dong” by searching for all the geographic data of the administrative area 200 corresponding to “Bangi-dong”.

Here, when no temple is retrieved from “Bangi-dong”, the second query processing method may expand a nearby search through a circular search method (see FIG. 3) using the radius of the first query processing method or through a method of searching for corresponding information from “Songpa-gu” that is an upper administrative area of “Bangi-dong”.

However, as illustrated in FIG. 3, in the case of expanding a search radius 310 using the circular search method due to absence of corresponding information in a predetermined administrative area 300, the second query processing method may conduct a nearby search based on an administrative area in a relatively small administrative area, however, may not expand the search radius 310 and accordingly may not conduct a nearby search in a relatively large administrative area.

As described above, in the case of conducting a circular search using a radius or conducting an expanded search using a simple upper administrative area, a geographically and actually nearby administrative area may not be considered. Accordingly, when conducting a nearby search using an administrative area, a nearby administrative area may not be included in a search radius or the nearby administrative area may not belong to an upper administrative area. In this case, the nearby administrative area may be omitted from a search result and thus, the accuracy and reliability of a nearby search result may not be guaranteed.

### SUMMARY

An aspect of the present invention provides a search system and method for effectively expanding a search area in response to a nearby search query.

Another aspect of the present invention also provides a search system and method for providing a more accurate nearby search function using administrative area information.

According to an aspect of the present invention, there is provided a search system, including a setter configured to set, as a search area, an administrative district corresponding to an administrative name in response to a query including the administrative name, and a searcher configured to conduct a search associated with the query in the search area. Here, the setter may expand the search area to another administrative district adjacent to the administrative district when a search result obtained from the search area is unsatisfactory.

At least one other administrative district may be adjacent to the administrative district.

When a plurality of other administrative districts is adjacent to the administrative district, the setter may assign a weight to each of the other administrative districts adjacent to the administrative district.

The weight may be determined based on at least one of a search area setting frequency of each of the other administrative districts, a recent search history of each of the other administrative districts, a traffic congestion of each of the other administrative districts, the number of facility objects of each of the other administrative districts, a facility distribution of each of the other administrative districts, a scale of each of the other administrative districts, a distance between the administrative district corresponding to the administrative name and each of the other administrative districts, and a direction in which each of the other administrative districts is located based on the administrative district corresponding to the administrative name.

The setter may set all the administrative districts directly adjacent to the administrative district as the search area. The setter may set, as an additional search area associated with the query, the other administrative district adjacent to the administrative district based on the weight.

The searcher may conduct a search in the other administrative district set as the search area based on the weight.

According to another aspect of the present invention, there is provided a search system, including a database configured to store information on another administrative district adjacent to an administrative district for each administrative district that a map area is divided based on an administrative unit, a setter configured to set, as a search area, an administrative district corresponding to an administrative name or the other administrative district adjacent to the administrative district in response to a query including the administrative name, and a searcher configured to conduct a search associated with the query in the search area.

The setter may set the administrative district corresponding to the administrative name as an initial search area associated with the query, and may set all the other administrative districts directly adjacent to the administrative district as an additional search area associated with the query, when a search result obtained from the initial search area is unsatisfactory.

According to still another aspect of the present invention, there is provided a search method, including setting an administrative district corresponding to an administrative name as an initial search area associated with a query, in response to the query including the administrative name, conducting a search associated with the query in the initial search area, setting another administrative district adjacent to the administrative district as an additional search area associated with the query when a search result obtained from the initial search area is unsatisfactory, and conducting an additional search associated with the query in the additional search area.

### Effect

According to embodiments of the present invention, it is possible to enhance a search performance through an effective search area setting of setting a search area based on a nearby administrative area in response to a nearby search query using an administrative area.

Also, according to embodiments of the present invention, it is possible to provide a more accurate search result by searching for additional information from a geographically and actually nearby administrative area when desired information is not retrieved from a predetermined administrative area corresponding to a query.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIGS. 1 through 3 illustrate examples of a map screen describing a nearby search method according to the related art;

FIG. 4 is a block diagram illustrating a configuration of a search system for conducting a nearby search using nearby administrative area information according to one embodiment;

FIG. 5 illustrates an example of a map screen describing a method of expanding a search area to a nearby administrative area according to one embodiment; and

FIG. 6 is a flowchart illustrating a search method for conducting a nearby search using nearby administrative area information according to one embodiment.

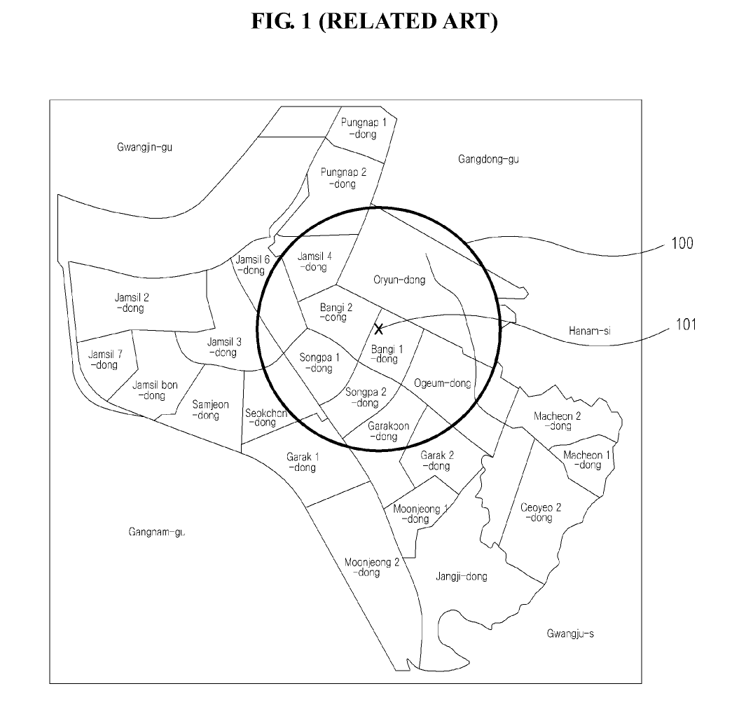

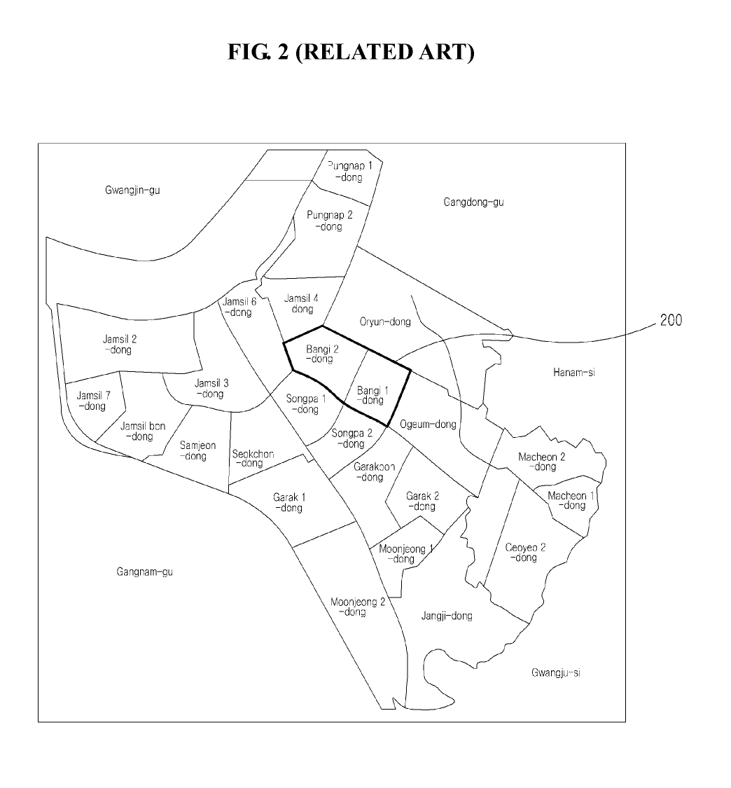

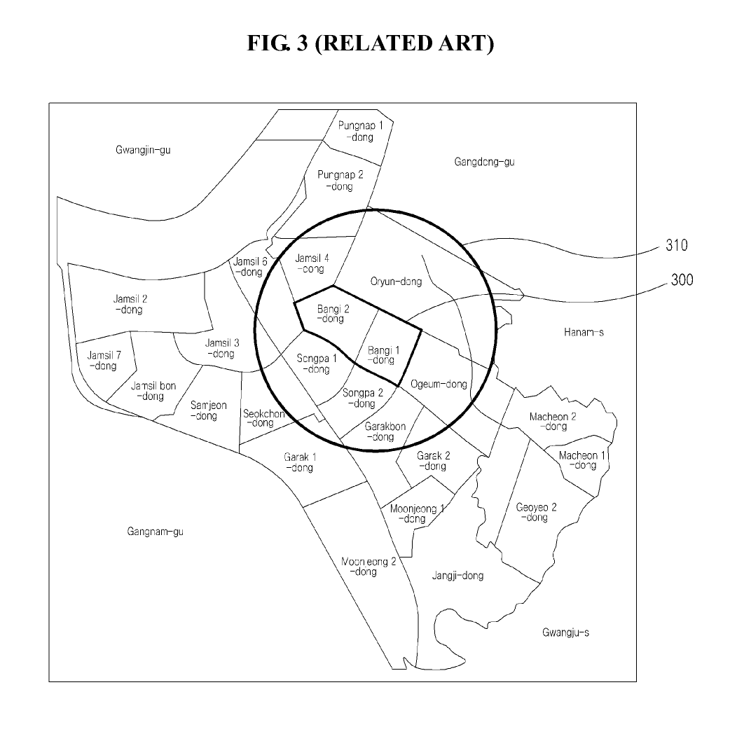

### DETAILED DESCRIPTION

Reference will now be made in detail to embodiments of the present invention, examples of which are illustrated in the accompanying drawings, wherein like reference numerals refer to like elements throughout. Embodiments are described below to explain the present invention by referring to the figures.

The embodiments herein propose a new method of setting a search area in response to a nearby search query.

The embodiments herein may be applicable to a search system for searching for geographic data and a variety of information, such as information actually present on a map or information matching the map as virtual information. In particular, the embodiments herein may be applicable to a search system for conducting a nearby search using an administrative area that a map area is divided based on an administrative unit.

The term “administrative area” used herein may indicate an administrative district that an area of a nation is divided based on an administrative unit for the purpose of a national administration and thus, the terms “administrative area” and “administrative district” may be interchangeably used throughout. Here, an administrative unit of the administrative area may vary depending on the administrative affairs for each nation. For example, the Republic of Korea is divided based on “metropolitan city”, “megalopolis”, “-do”,“-si”, “-gun”, “ ”, “-eup”, “-myeon”, “-dong”, and “-lee”.

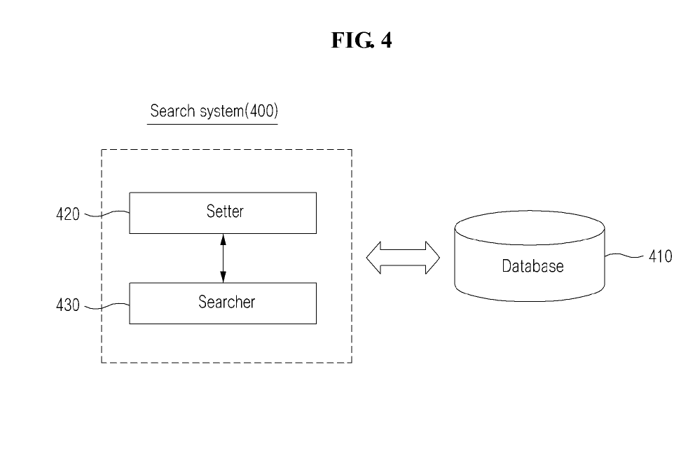

FIG. 4 is a block diagram illustrating a configuration of a search system 400 for conducting a nearby search using nearby administrative area information according to an embodiment of the present invention.

Referring to FIG. 4, the search system 400 may include a database 410, a setter 420, and a searcher 430.

The search system 400 may be configured on a server system configured to provide a map search service to a service user in a web environment or a mobile environment, or may be configured on a terminal device capable of conducting a map search, for example, a personal computer (PC), a laptop computer, a navigation terminal, a smartphone, a tablet, a digital multimedia broadcasting (DMB) terminal, and a portable multimedia player (PMP).

When generating administrative area information for a search, the embodiments herein may generate in advance, information (hereinafter, “nearby administrative area”) on an administrative area adjacent to a corresponding administrative district with respect to each of administrative districts divided based on an administrative unit, and may construct a nearby administrative area for each administrative district based on each administrative unit, for example, “metropolitan city”, “megalopolis”, “-do”,“-si”, “-gun”, “-gu”, “-eup”, “-myeon”, “-dong”, and “-lee”. Also, the terms “nearby administrative area” and “another administrative district” may be interchangeably used throughout.

Here, the nearby administrative area may include all the administrative areas of which at least a portion is geographically directly adjacent to a predetermined administrative area regardless of an upper administrative area.

When constructing a nearby administrative area among administrative units, nearby administrative areas of, for example, “Bangi-dong” may include “Garak-dong”, “Songpa-dong”, “Jamsil-dong”, “Poongnap-dong”, “Seongnae-dong”, and “Dongchon-dong”, and nearby administrative areas of “Samjeon-dong” may include “Jamsil-dong”, “Seokchon-dong”, “Garak-dong”, “Suseo-dong”, “Ilwon-dong”, and “Daechi-dong”.

An index may be assigned to each administrative unit and each administrative area is divided based on an administrative unit. Using the index, an administrative area and a corresponding nearby administrative area may be managed.

The database 410 may store and maintain administrative area information for a search. That is, the database 410 may store information on a nearby administrative area of which at least a portion is adjacent to a corresponding administrative area, for each administrative area. Here, the database 410 may be configured into a single system together with a map database configured to store geographic data about the whole country map, or may be configured as a separate system from the map database

The database 410 may store, as administrative area information, a nearby administrative area list including at least one nearby administrative area adjacent to an administrative area. Here, the nearby administrative area list may further include additional information on at least one of a search area setting frequency of each nearby administrative area, a recent search history of each nearby administrative area, a traffic congestion of each nearby administrative area, the number of facility objects of each nearby administrative area, a facility distribution of each nearby administrative area, a scale of each nearby administrative area, a distance between the administrative area and each nearby administrative area, for example, a distance between central coordinates of the administrative area and central coordinates of each nearby administrative area, and a direction in which each nearby administrative area is located based on the administrative area, for example, an order in which each nearby administrative area is located in a clockwise direction or a counterclockwise direction, starting from 12-hour direction of the administrative area. Real-time information such as a frequency order, a search order, and traffic congestion may need to be periodically updated in the database 410. The additional information may be used for a process of setting a search area in response to a nearby search query and/or a process of conducting a search associated with a query in a search area.

The setter 420 may set a search area in response to a query including an administrative name. Here, the administrative name included in the query may be extracted from a keyword, for example, “temple around Bangi-dong”, directly input from a user, or may use location information, for example, “Bangi-dong” of a user terminal having requested a search.

Preferentially, the setter 420 may set, as an initial search area for a search, an administrative area corresponding to the administrative name using the administrative name included in the query.

Further, the setter 420 may expand a search area in preparation for a case in which a search result obtained from the initial search area is unsatisfactory. Here, the setter 420 may set, as an additional search area associated with the corresponding query, a nearby administrative area of the administrative area set as the initial search area based on the database 410.

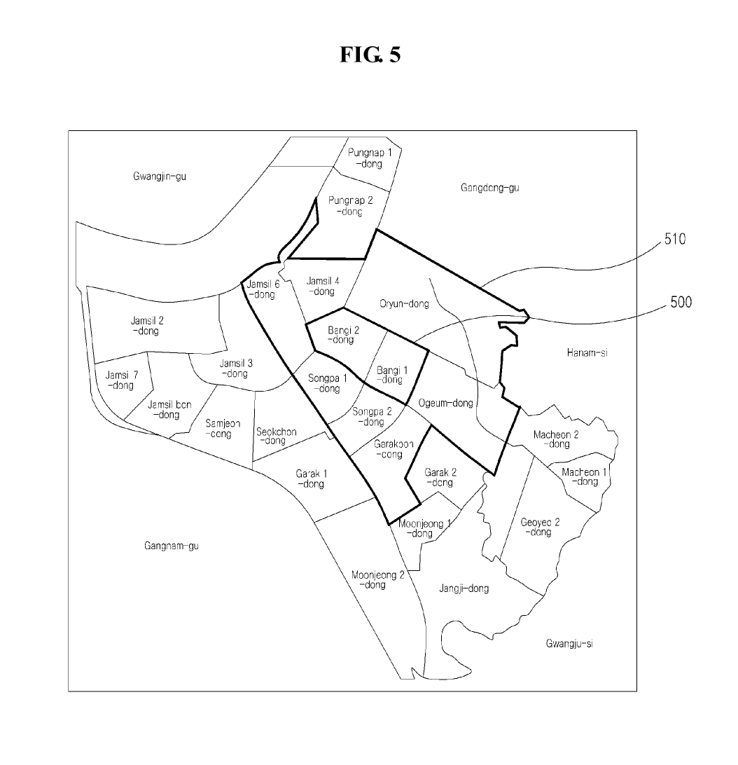

For example, referring to FIG. 5, when an administrative name included in a query is “Bangi-dong”, administrative areas “Bangi 1-dong” and “Bangi 2-dong” may be set as an initial search area 500. When an additional search is required, administrative areas “Jamsil 4-dong”, “Jamsil 6-dong”, “Songpa 1-dong”, “Songpa 2-dong”, “Garakbon-dong”, “Ogeum-dong”, and “Oryun-dong” geographically directly adjacent to “Bangi 1-dong” and “Bangi 2-dong” may be set as an additional search area 510.

Meanwhile, when an administrative name included in a query is “Samjeon-dong”, “Samjeon-dong” may be set as an initial search area. When an expanded search is required, “Jamsil-dong”, “Seokchon-dong”, “Garak-dong”, “Suseo-dong”, “Ilwon-dong”, and “Daechi-dong” adjacent to “Samjeon-dong” may be set as an additional search area. Also, when an administrative name included in a query is “Yongsan-gu” corresponding to the administrative unit “-gu”, “Yongsan-gu” may be set as an initial search area. When an expanded search is required, nearby districts adjacent to “Yongsan-gu”, that is, “Mapo-gu”, “Jung-gu”, “Seongdong-gu”, “Gangnam-gu”, “Seocho-gu”, “Dongjak-gu”, and “Yeongdeungpo-gu” may be set as an additional search area.

Also, the setter 420 may gradually expand the additional search area using another nearby administrative area adjacent to a nearby administrative set as the additional search area, based thereon. That is, until a satisfactory search result is obtained with respect to a query, the setter 420 may support the additional search while expanding a search area using a nearby administrative area.

When a plurality of administrative areas is present, the setter 420 may assign a weight to each administrative area. Here, the weight may be determined based on additional information stored in the database 410 and thus, may be determined based on at least one of a search area setting frequency of each nearby administrative area, a recent search history of each nearby administrative area, a traffic congestion of each nearby administrative area, the number of facility objects of each nearby administrative area, a facility distribution of each nearby administrative area, a scale of each nearby administrative area, a distance between the administrative area and each nearby administrative area, and a direction in which each nearby administrative area is located based on the administrative area. For example, a relatively high weight may be assigned to a nearby administrative area relatively frequently set as a search area, a nearby administrative area most recently retrieved, a nearby administrative area having a relatively small traffic amount, a nearby administrative area having a relatively large number of facility objects or having a relatively large distribution, a nearby administrative area having a relatively large scale, and a nearby administrative area of which central coordinates are relatively close to central coordinates of the administrative area.

Accordingly, when expanding a search area, the setter 420 may set, as an additional search area, all the nearby administrative areas geographically adjacent to an administrative area corresponding to an initial search area and may also set the additional search area using a weight assigned to each nearby administrative area. As an example, the setter 420 may set, as an additional search area, at least a portion of nearby administrative areas having a relatively high weight among nearby administrative areas, based on weights assigned thereto. Referring again to FIG. 4, the searcher 430 may conduct a search associated with the corresponding query in the search area set by the setter 420.

When the initial search area associated with the query is set by the setter 420, the searcher 430 may conduct a search associated with the query in the set initial search area.

In particular, when a search result obtained from the initial search area is unsatisfactory, for example, when desired information is not retrieved from the initial search area or when only predetermined items of information are retrieved as the search result obtained from the initial search area, the searcher 430 may additionally conduct a search associated with the query in the additional search area expanded to nearby administrative areas through the setter 420.

For example, referring again to FIG. 5, when an administrative name included in a query is “Bangi-dong”, a search is conducted in the initial search area 500 including administrative areas “Bangi 1-dong” and “Bangi 2-dong”. When desired information is not retrieved from “Bangi 1-dong” and “Bangi 2-dong” corresponding to the initial search area 500, an expanded search may be conducted in the additional search area 510 including “Jamsil 4-dong”, “Jamsil 6-dong”, “Songpa 1-dong”, “Songpa 2-dong”, “Garakbon-dong”, “Ogeum-dong”, and “Oryun-dong”.

Here, when conducting an additional search in nearby administrative areas set as an additional search area, the searcher 430 may conduct the additional search based on weights assigned to the nearby administrative areas. In detail, the searcher 430 may integrally conduct the additional search in the entire nearby administrative areas set as the additional search area, or may sequentially conduct the additional search based on weights assigned to the nearby administrative areas.

According to the above configuration, the search system 400 may enhance a search performance and may more accurately conduct a nearby search by expanding a search area using a geographically directly nearby administrative area when expanding a search area associated with a query.

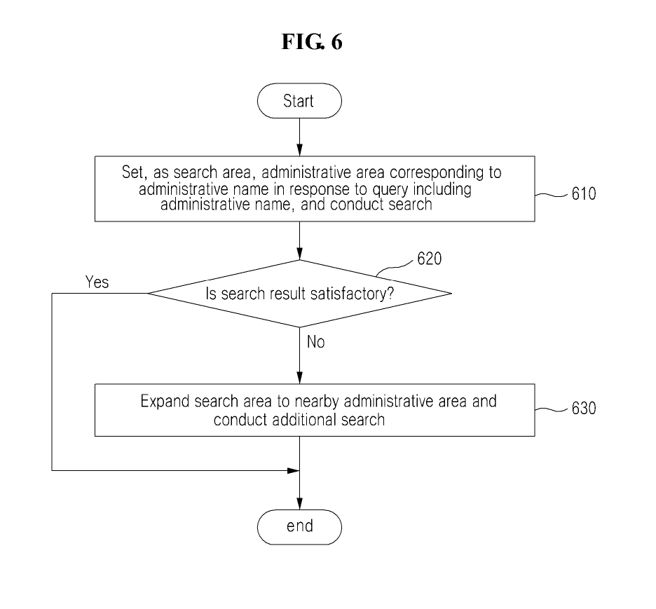

FIG. 6 is a flowchart illustrating a search method for conducting a nearby search using nearby administrative area information according to an embodiment of the present invention. Operations of the search method of FIG. 6 may be performed by a search system described above with reference to FIGS. 4 and 5.

In operation S601, the search system may set, as an initial search area, an administrative area corresponding to an administrative name in response to a query including the administrative name, and may conduct a search associated with the query in the set initial search area.

In operation S602, the search system may determine whether a search result obtained from the initial search area is satisfactory. For example, the search system may verify whether desired information is retrieved from the initial search area, or whether at least a predetermined number of items of information are retrieved as the search result from the initial search area.

In operation S603, the search system may expand the search area when the search result obtained from the initial search area is unsatisfactory. Here, the search system may set, as an additional search area, a nearby administrative area geographically adjacent to the administrative area set as the initial search area. Accordingly, the search system may conduct an additional search associated with the query in the additional search area expanded to the nearby administrative area.

Further, when a plurality of nearby administrative areas is adjacent to the administrative area corresponding to the initial search area, the search system may assign a weight to each of the nearby administrative areas. Here, the weight may be determined based on at least one of a search area setting frequency of each nearby administrative area, a recent search history of each nearby administrative area, a traffic congestion of each nearby administrative area, the number of facility objects of each nearby administrative area, a facility distribution of each nearby administrative area, a scale of each nearby administrative area, a distance between the administrative area and each nearby administrative area, and a direction in which each nearby administrative area is located based on the administrative area.

Here, the search system may set, as the additional search area, all the nearby administrative areas geographically adjacent to the administrative area corresponding to the initial search area and may also set nearby administrative areas as the additional search area, based on a weight assigned to each nearby administrative area. Also, when conducting an additional search in nearby administrative areas set as the additional search area, the search system may integrally conduct the additional search in the entire nearby administrative areas set as the additional search area, or may sequentially conduct the additional search based on weights assigned to the nearby administrative areas.

The search method may include a further reduced number of operations or additional operations based on the description related to the search system made above with reference to FIGS. 4 and 5. Also, at least two operations may be combined with each other and orders or locations of operations may be changed.

The methods according to embodiments of the present invention may be recorded in non-transitory computer-readable media in a program instruction form executable through various computer systems. In particular, the embodiments may include non-transitory computer-readable media including a program that includes setting an administrative district corresponding to an administrative name as an initial search area associated with a query, in response to the query including the administrative name; conducting a search associated with the query in the initial search area; setting another administrative district adjacent to the administrative district as an additional search area for the query when a search result obtained from the initial search area is unsatisfactory; and conducting an additional search associated with the query in the additional search area.

The program according to the embodiments may be configured as a PC-based program or an application exclusive for a mobile terminal. An application (App) for a map search according to the embodiments may be configured as an independently operating program or an in-app form of a predetermined application, for example, a find-a-way program to be operable on the predetermined application.

As described above, according to embodiments herein, it is possible to enhance a search performance through an effective search area setting of setting a search area based on a nearby administrative area in response to a nearby search query using an administrative area. Further, according to embodiments herein, it is possible to provide a more accurate search result by searching for additional information from a geographically and actually nearby administrative area when desired information is not retrieved from a predetermined administrative area corresponding to a query.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A search system, comprising:
a setter configured to set, as a search area, an administrative district corresponding to an administrative name in response to a query comprising the administrative name; and
a searcher configured to conduct a search associated with the query in the search area,
wherein the setter is configured to expand the search area to another administrative district adjacent to the administrative district when a search result obtained from the search area is unsatisfactory.

2. The search system of claim 1, wherein at least one other administrative district is adjacent to the administrative district.

3. The search system of claim 1, wherein when a plurality of other administrative districts is adjacent to the administrative district, the setter is configured to assign a weight to each of the other administrative districts adjacent to the administrative district.

4. The search system of claim 3, wherein the weight is determined based on at least one of a search area setting frequency of each of the other administrative districts, a recent search history of each of the other administrative districts, a traffic congestion of each of the other administrative districts, a number of facility objects of each of the other administrative districts, a facility distribution of each of the other administrative districts, a scale of each of the other administrative districts, a distance between the administrative district corresponding to the administrative name and each of the other administrative districts, or a direction in which each of the other administrative districts is located based on the administrative district corresponding to the administrative name.

5. The search system of claim 1, wherein the setter is configured to set all the administrative districts directly adjacent to the administrative district as the search area.

6. The search system of claim 3, wherein the setter is configured to set, as an additional search area associated with the query, the other administrative district adjacent to the administrative district based on the weight.

7. The search system of claim 3, wherein the searcher is configured to conduct a search in the other administrative district set as the search area based on the weight.

8. A search system, comprising:
a database configured to store information on another administrative district adjacent to an administrative district for each administrative district that a map area is divided based on an administrative unit;
a setter configured to set, as a search area, an administrative district corresponding to an administrative name or the other administrative district adjacent to the administrative district in response to a query comprising the administrative name; and
a searcher configured to conduct a search associated with the query in the search area.

9. The search system of claim 8, wherein the database is configured to store information on a search area setting frequency of each of other administrative districts, a recent search history of each of the other administrative districts, a traffic congestion of each of the other administrative districts, a number of facility objects of each of the other administrative districts, a facility distribution of each of the other administrative districts, a scale of each of the other administrative districts, a distance between the administrative district corresponding to the administrative name and each of the other administrative districts, or a direction in which each of the other administrative districts is located based on the administrative district corresponding to the administrative name.

10. The search system of claim 8, wherein at least one other administrative district is adjacent to the administrative district.

11. The search system of claim 8, wherein when a plurality of other administrative districts is adjacent to the administrative district, the setter is configured to assign a weight to each of the other administrative districts adjacent to the administrative district.

12. The search system of claim 11, wherein the weight is determined based on at least one of a search area setting frequency of each of the other administrative districts, a recent search history of each of the other administrative districts, a traffic congestion of each of the other administrative districts, the number of facility objects of each of the other administrative districts, a facility distribution of each of the other administrative districts, a scale of each of the other administrative districts, a distance between the administrative district corresponding to the administrative name and each of the other administrative districts, or a direction in which each of the other administrative districts is located based on the administrative district corresponding to the administrative name.

13. The search system of claim 8, wherein the setter is configured to set the administrative district corresponding to the administrative name as an initial search area associated with the query, and to set all the other administrative districts directly adjacent to the administrative district as an additional search area associated with the query, when a search result obtained from the initial search area is unsatisfactory.

14. The search system of claim 11, wherein the setter is configured to set the administrative district corresponding to the administrative name as an initial search area associated with the query, and to set, as an additional search area associated with the query, the other administrative district adjacent to the administrative district based on the weight, when a search result obtained from the initial search area is unsatisfactory.

15. The search system of claim 11, wherein the searcher is configured to conduct a search in the other administrative district set as the search area based on the weight.

16. A search method, comprising:
setting an administrative district corresponding to an administrative name as an initial search area associated with a query, in response to the query comprising the administrative name;
conducting a search associated with the query in the initial search area;
setting another administrative district adjacent to the administrative district as an additional search area associated with the query when a search result obtained from the initial search area is unsatisfactory; and
conducting an additional search associated with the query in the additional search area.

17. The method of claim 16, wherein at least one other administrative district is adjacent to the administrative district.

18. The method of claim 16, further comprising:
assigning a weight to each of a plurality of other administrative districts adjacent to the administrative district when the plurality of other administrative districts is adjacent to the administrative district.

19. The method of claim 18, wherein the weight is determined based on at least one of a search area setting frequency of each of the other administrative districts, a recent search history of each of the other administrative districts, a traffic congestion of each of the other administrative districts, a number of facility objects of each of the other administrative districts, a facility distribution of each of the other administrative districts, a scale of each of the other administrative districts, a distance between the administrative district corresponding to the administrative name and each of the other administrative districts, or a direction in which each of the other administrative districts is located based on the administrative district corresponding to the administrative name.

20. The method of claim 16, wherein the setting another administrative district adjacent to the administrative district as an additional search area comprises setting all the other administrative districts directly adjacent to the administrative district as the additional search area.

21. The method of claim 18, wherein the setting of the other administrative district adjacent to the administrative district as the additional search area comprises setting, as the additional search area, the other administrative districts adjacent to the administrative district based on the weight.

22. The method of claim 18, wherein the conducting of the additional search associated with the query comprises conducting a search in the other administrative districts set as the additional search area based on the weight.

23. Non-transitory computer-readable media comprising an instruction to control a computer system for a map search, wherein the instruction controls the computer system by a method comprising:
setting an administrative district corresponding to an administrative name as an initial search area associated with a query, in response to the query comprising the administrative name;
conducting a search associated with the query in the initial search area;
setting another administrative district adjacent to the administrative district as an additional search area associated with the query when a search result obtained from the initial search area is unsatisfactory; and
conducting an additional search associated with the query in the additional search area.
